(19) United States
(12) Patent Application Publication
(10) Pub. No.: US 2012/0070724 A1
(43) Pub. Date: Mar. 22, 2012

(54) BUFFER STRUCTURE FOR A LEAD ACCUMULATOR CONTAINER

(76) Inventor: Chih-Hsiung CHEN, Caotun Township (TW)

(21) Appl. No.: 12/887,706

(22) Filed: Sep. 22, 2010

(51) Int. Cl. H01M 2/10

(52) U.S. Cl. 429/186

(57) ABSTRACT

A buffering structure for a lead accumulator container comprises an accumulator container including plural holding grooves for accommodation of electrode pads. The holding grooves are spaced by partition walls. Between the holding grooves are provided plural buffer spaces including support members to separate the holding grooves, improving the diffusion of the heat energy generated by the reaction of the accumulator while avoiding the undesired temperature increase in the accumulator. With support members, the buffer spaces won't deform after heating up, effectively avoiding the damages to the interior of the accumulator due to high temperature. Furthermore, the arrangement of the buffer spaces can effectively reduce the total volume of the holding grooves and correspondingly reduce the quantity of the electrode plates and electrolyte, achieving the objectives of reducing the total weight and material cost.

### BACKGROUND OF THE INVENTION

1. Field of the Invention

The present invention relates to a lead accumulator container, and more particularly to a buffer structure for a lead accumulator container.

2. Description of the Prior Art

A conventional lead accumulator is provided with plural neighboring holding grooves in an accumulator container. In the respective holding grooves are provided plural electrode pads which are in order connected to one another through a connecting element spanning the corresponding holding groove to form a closed loop. In such a structure, since the neighboring holding grooves are spaced by a wall, when generation chemical reaction proceeds and generates heat energy in the respective holding grooves, the heat energy in the respective holding grooves will be transferred to its neighboring holding groove through the wall therebetwen, and therefore, the heat energy produced in the respective holding grooves cannot be effectively diffused but will receive the heat energy from the neighboring groove, thus leading to the undesired accumulation of the heat energy. As a result, the temperature in the respective holding grooves will increase gradually and then exceed the normal working value to make the relating structure produce heat strain which is prone to leading to undesired damages or even structure melting, correspondingly shortening the service life of the whole structure.

In addition, the accumulator has to be suited for the installation environment and structure, so its volume or size cannot be changed as desired. Nowadays, the improvement in material technology makes it possible to produce the accumulator with less material, however, the size and configuration of the accumulator are still unchangeable, and so is the internal design of the accumulator because limited by the conventional volume, making the total weight unlikely to be reduced substantially. In addition, the reacting area and the number of the electrode pads cannot be reduced either, so it is less likely to effectively reduce the material cost.

The present invention has arisen to mitigate and/or obviate the afore-described disadvantages.

### SUMMARY OF THE INVENTION

The primary objective of the present invention is to provide a buffer structure for a lead accumulator container which can effectively isolate heat transfer and avoid temperature increase caused by accumulation of heat, the buffer structure for a lead accumulator container comprises plural buffer spaces between holding grooves in which electrode pads are disposed to prevent the heat energy generated in the respective holding grooves from being mutually transferred and accumulated, and in the buffer spaces are disposed plural support members for preventing the buffer spaces from deforming after heating up.

The secondary objective of the present invention is to provide a buffer structure for a lead accumulator container which can reduce the total material cost by reducing the quality of the electrode pads and the electrolyte, the buffer structure for a lead accumulator container comprises plural buffer spaces between holding grooves in which electrode pads are disposed to relatively reduce the total volume of the holding grooves in the accumulator container which has a fixed external shape and volume, and the quality of the electrode pads and the electrolyte in the holding grooves are correspondingly reduced, cutting down the material cost as well as the maintenance cost in the future.

The third objective of the present invention is to provide a buffer structure for a lead accumulator container which can relatively reduce the total weight of the accumulator by providing buffer spaces between holding grooves.

### BRIEF DESCRIPTION OF THE DRAWINGS

FIG. 1 is an exploded view of a buffering structure for a lead accumulator container in accordance with the present invention;

FIG. 2 is a perspective view of the buffering structure for a lead accumulator container in accordance with the present invention

FIG. 3 is a transverse cross-sectional view of the buffering structure for a lead accumulator container in accordance with the present invention; and

FIG. 4 is longitudinal cross-sectional view of the buffering structure for a lead accumulator container in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

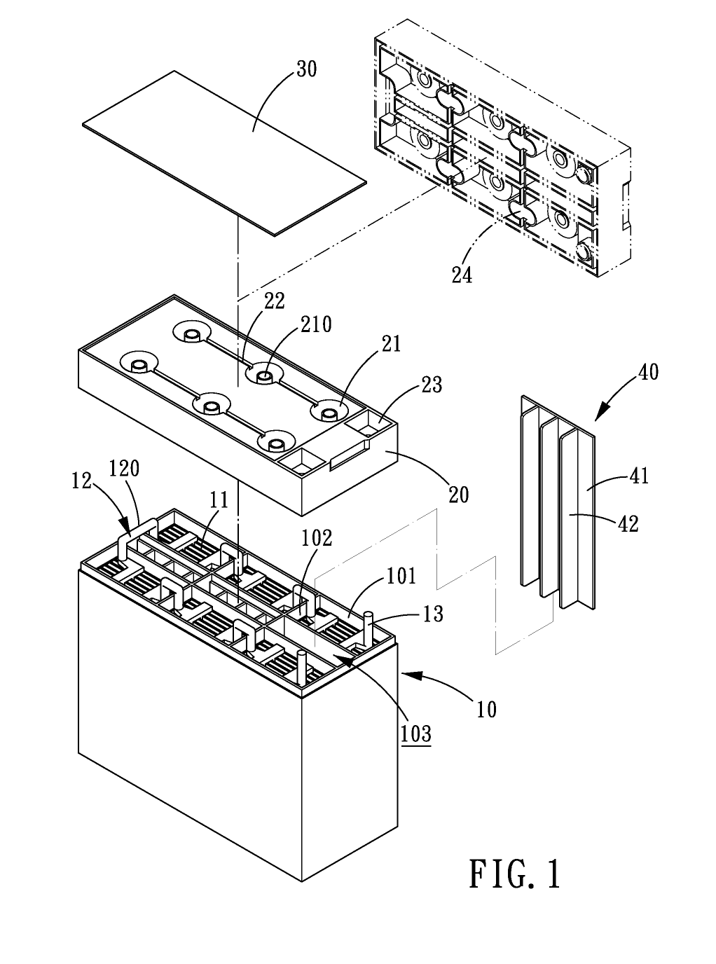

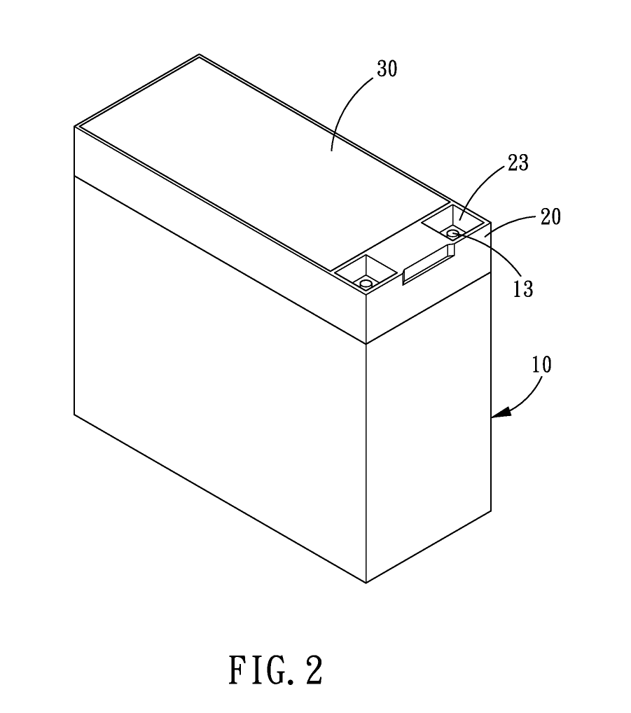

Referring to FIGS. 1-2, a buffering structure for a lead accumulator container in accordance with the present invention comprises an accumulator container 10. The accumulator container 10 is interiorly provided with plural holding grooves 101, and the plural holding grooves 101 are spaced from each other by a partition wall 102. Each of the holding grooves 101 is interiorly provided with plural parallel electrode pads 11. A first end of a top portion of the respective electrode pads 11 in one of the holding grooves 101 is connected to a second end of the top portion of the respective electrode pads 11 in another neighboring holding groove 101 by a connecting element 12 spanning the two neighboring holding grooves 101 and the partition wall 102. The connecting elements 12 each are provided with an arched spanning portion 120 which spans the respective partition walls 102 to connect all the electrode pads 11 into a closed loop. The closed loop is provided at each of two ends thereof with an electrode element 13 serving as output terminals of the lead accumulator.

An intermediate member 20 covers the top of the accumulator container 10 and is formed with plural round receiving grooves 21 open upwards. The round receiving grooves 21 are aligned with the respective holding grooves 101. At a center of the respective receiving grooves 21 is formed a hollow ventilated portion 210 extending upwards from a bottom of the respective receiving grooves 21. The respective receiving grooves 21 are brought in communication with one another through a guide groove 22. A cover plate 30 is disposed on the intermediate member 20 and covers all the receiving grooves 21. The intermediate member 20 is further formed with two through holes 23 for insertion of the electrode elements 13. The intermediate member 20 is further formed with plural concave portions 24 correspondingly to the respective spanning portions 120 of the connecting elements 12 in such a manner that when the intermediate member 20 covers the accumulator container 10, the spanning portions 120 are just inserted in the respective concave portions 24.

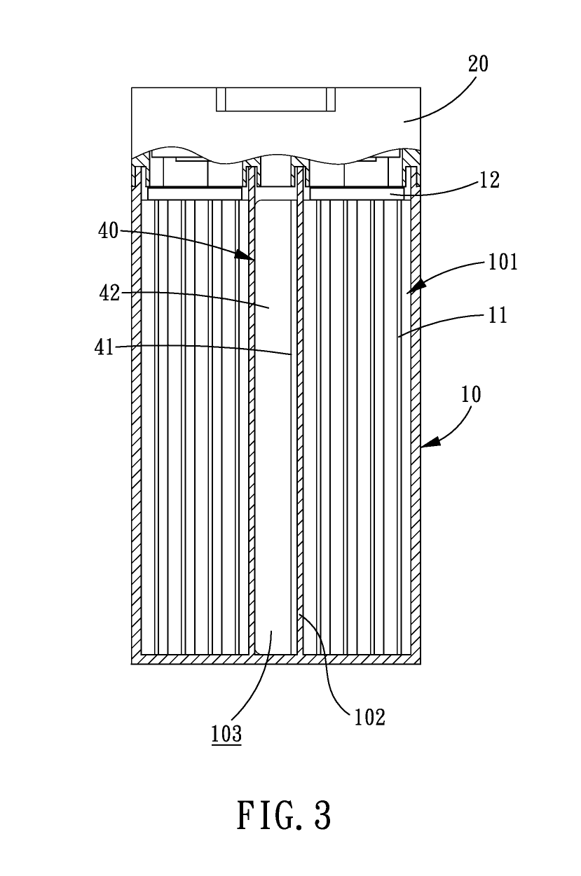

The present invention is characterized in that, as shown in FIG. 3, the accumulator container 10 is interiorly provided with three neighboring holding grooves 101 at each of two sides thereof while the accumulator container 10 is interiorly provided in the middle portion thereof with three continuous buffer spaces 103 by which the holding grooves 101 at two sides of the accumulator container 10 are separated. Hence, the heat energy generated in the respective holding grooves 101 will be transferred into the buffer spaces 103 via the partition wall 102 and then radiated instead of being conducted to the neighboring holding groove 101, thus realizing the objective of heat isolation while avoiding the heat energy accumulation due to direct conduction.

Referring to FIGS. 1 and 3 again, each of the buffer spaces 103 can also be provided with a support member 40 which includes a back plate 41 and plural spaced sheet-shaped support portions 42 formed on the back plate 41. The support members 40 are disposed in the respective buffer spaces 103 in such a manner that the back plate 41 of the respective support members 40 abut against one side of the corresponding buffer surface 103 while the respective support portions 42 abut against the other side of the corresponding buffer space 103, preventing heat energy generated during the reaction of the electrolytic in the respective holding grooves 101 from making the buffer spaces 103 deform, maintaining the volume of the respective buffer spaces 103.

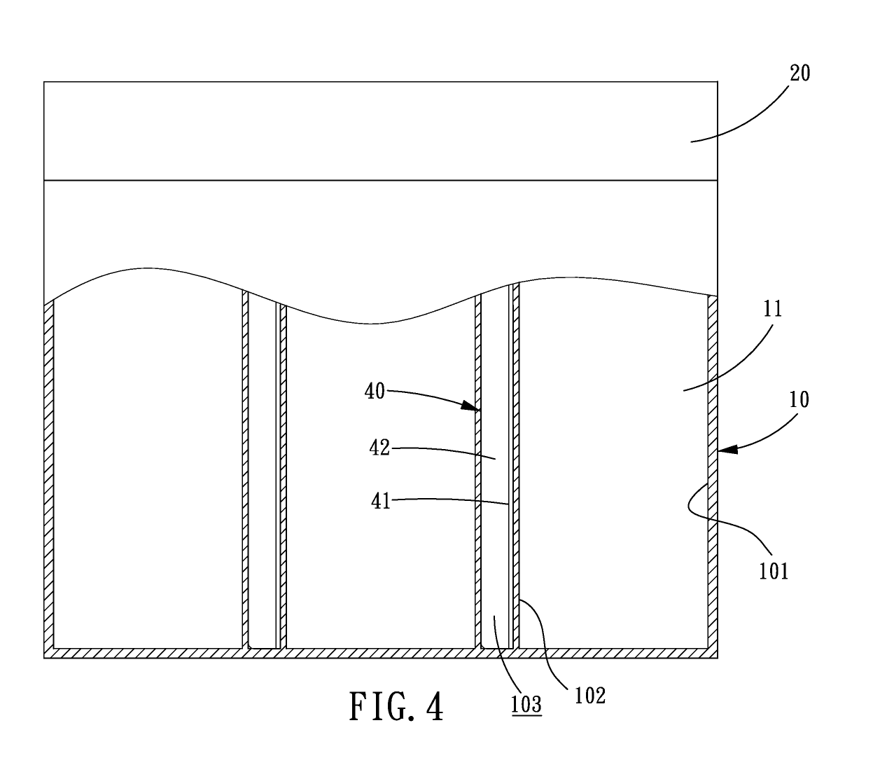

Further referring to FIG. 4, between the respective holding grooves 101 at each of two sides of the accumulator container 10 can also be disposed a buffer space 103 to separate the holding grooves 101 substantially for further enhancing the heat buffer effect.

The above buffer spaces 103 are disposed in the accumulator container 10 and located at a circumference of the respective holding grooves 101, preventing the neighboring holding grooves 101 from transferring heat to each other, namely offering the following functions:

1. avoiding direct heat transfer: with the buffer spaces 103 between the respective holding grooves 101, the heat energy in the respective holding grooves 101 cannot be directly transferred, avoiding the undesired accumulation of the heat, ensuring a normal working temperature range, and keeping the optimal generation efficiency.

2. reducing the damage caused by heat strain: since the heat is normally transferred from a higher enthalpy position to a lower enthalpy position, and the enthalpy of the buffer space is obviously lower than that of the holding grooves 101, the heat energy is normally transferred from the holding grooves 101 to the buffer spaces 103, avoiding the heat accumulation and temperature increase, and therefore, the accumulator container 10 can be kept working within the normal working temperature range, reducing the damage caused by high temperature heat strain.

3. reduction of material cost: due to the arrangement of the buffer spaces 103, the total volume of the holding grooves 101 can be relatively reduced, and the area of the electrode pads 11 in the holding grooves 101 and the amount of the electrolyte are correspondingly reduced, cutting down the material cost as well as the maintenance cost in the future.

4. reduction of total weight: due to the arrangement of the buffer spaces 103, the internal material required for the accumulator container 10 is reduced, thus reducing the total use amount of the material, and as result of this, the total weight of the accumulator container 10 can be effectively reduced.

While we have shown and described various embodiments in accordance with the present invention, it is clear to those skilled in the art that further embodiments may be made without departing from the scope of the present invention.

What is claimed is:

1. A buffering structure for a lead accumulator container comprising:
an accumulator container provided with plural holding grooves which are spaced by partition walls;
plural buffer spaces each disposed between the plural holding grooves; and
plural support members disposed in the respective buffer spaces.

2. The buffering structure for a lead accumulator container as claimed in claim 1, wherein the holding grooves are disposed at two sides of the accumulator container, and in the middle portion of the accumulator container are, in order, provided, the plural buffer spaces for spacing the holding grooves at the two sides of the accumulator.

3. The buffering structure for a lead accumulator container as claimed in claim 1, wherein the holding grooves are disposed at two sides of the accumulator container, the plural buffer spaces are disposed at a circumference of the respective holding grooves for spacing each two neighboring holding grooves.

4. The buffering structure for a lead accumulator container as claimed in claim 1, wherein each of the support members includes a back plate and plural spaced sheet-shaped support portions formed on the back plate, the back plate and the support portions of the respective support members abut against both sides of the corresponding buffer space.
